(19) United States
(12) Patent Application Publication
(10) Pub. No.: US 2010/0267068 A1
(43) Pub. Date: Oct. 21, 2010

(54) ANALYSIS OF DOPING COMPOUNDS

(76) Inventors: Douwe De Boer, Maastricht (NL); Bert Kip, Limbricht (NL); Ynze Mengerink, Vaesrade (NL); John Mommers, Meerssen (NL); Roland Peters, Roermond (NL); Nicolle Reumkens, Landgraaf (NL)

Correspondence Address: NIXON & VANDERHYE, PC, 901 NORTH GLEBE ROAD, 11TH FLOOR, ARLINGTON, VA, 22203, US

(21) Appl. No.: 12/668,929

(22) PCT Filed: Jul. 11, 2008
(86) PCT No.: PCT/EP08/05684

§ 371 Date: Jun. 25, 2010

(30) Foreign Application Priority Data
Jul. 13, 2007 (EP) 07 013 740.1

(51) Int. Cl. C12Q 1/34; G01N 33/50; C12M 1/34; G01N 30/00

(52) U.S. Cl. 435/18; 436/111; 436/93; 436/96; 436/112; 436/128; 436/92; 436/98; 436/63; 435/288.7; 422/69

(57) ABSTRACT

Process for determination of a drug or medicament or their metabolites in a (body) fluid or an extract of (body) tissue or (body) sample comprising the steps: (i) optionally treatment of the fluid or sample extract with at least one enzyme, (ii) contacting at least a first part of the fluid or extract with at least one first solid phase able to adsorb or absorb organic compounds out of the fluid or extract, and/or (iii) contacting at least a second part of the fluid or extract with at least one second phase, able to extract or adsorb organic compounds out of the fluid or extract, and/or (iv) optionally contacting at least a third part of the fluid or extract with a liquid phase able to extract organic compounds out of the fluid or extract, and/or (v) desorbing the compound(s) bound to the first solid phase by applying heat to the solid phase and/or by solvent extraction, optionally followed by evaporating the solvent at least partially, (vi) optionally extracting or desorbing the compound(s) contained in or bound to the second phase by applying heat and/or by solvent extraction, optionally followed by evaporation of the solvent at least partially and (vii) analyzing the desorbed compounds of steps (v) and (vi) and optionally the compounds extracted in step (iv) by multi-dimensional gas chromatography (GC), preferably by comprehensive multi-dimensional GC (GC*GC) coupled preferably to a mass spectrometry.

The present invention refers to a process for determination of a drug or a medicament or their metabolites in a (body) fluid or tissue/sample extract comprising a combination of solid-phase extraction and/or solid-phase micro extraction and/or derivatisation, and comprehensive multi-dimensional gas chromatography.

In many situations, it is desirable to know about any use of drugs or medicaments in a living organism. For example, metabolism of a medicament or monitoring of biochemical pathways may be of interest (for example in toxicological studies). Further, in several areas drugs and medicaments are used to enhance or increase any desired result, particularly in the area of sport and breeding. Such drugs or medicaments for example can be used to improve the power or the endurance of the athlete (human or animal) or to support any breeding process (for example faster growth of the animals).

To provide the possibility to determine the use (or abuse) of any medicament or drug there is a need of a fast, reliable and feasible process to determine the medicaments or drugs or their according metabolites in any (body) sample.

Therefore by the present invention a process for determination of a drug or medicament or their metabolites in a (body) fluid or tissue or other samples originating from an organism is provided which can be carried out within two or three hours (for the whole process) and is highly sensitive, therefore providing excellent results in short time.

The process of the present invention comprises the steps

(i) optionally treatment of a (body) fluid or an extract of (body) tissue or (body) sample with at least one enzyme, and/or optionally derivatisation to enhance sample preparation, e.g. derivatisation with an alkylhaloformate like e.g. ECF (ethylchloroformate).
(ii) contacting at least a first part of the fluid or extract with at least one first solid phase able to adsorb organic compounds out of the fluid or extract, and/or
(iii) contacting at least a second part of the fluid or extract with at least one second phase, able to extract or adsorb organic compounds out of the fluid or extract, and/or
(iv) optionally contacting at least a third part of the fluid or extract with a liquid phase able to extract organic compounds out of the fluid or extract
(v) desorbing the compound(s) bound to the first solid phase by applying heat to the solid phase, and/or by solvent extraction, optionally followed by evaporating the solvent at least partially and/or
(vi) optionally extracting or desorbing the compound(s) contained in or bound to the second phase by applying heat and/or by solvent extraction optionally followed by evaporating the solvent at least partially
(vii) analyzing the desorbed compounds of steps (v) and/or (vi) and optionally the compounds extracted in step (iv) by multi-dimensional gas chromatography (GC), preferably by comprehensive multi-dimensional GC (GC*GC) coupled preferably to a mass spectrometry.

A compound according to the use herein is any drug or medicament or its/their metabolites after biochemical pathways, preferably after biochemical pathways of a mammal, contained in any (body) fluid or tissue after intake (including injections or ointments) of said compound(s).

The (body) fluid, which can be analyzed with the process according to the present invention can be for example blood, urine, feces, liquid from the lachrymal canal, spinal liquid, brain liquid, liquid from the lymphatic gland, or any other obtainable body fluid. Because of the ease accessibility, the body fluid preferably is blood or urine. The potential intake of a drug or medicament can also be determined in a liquid, originating from an extraction with a suitable solvent of a substance or tissue in which the drug or its metabolite is present. In this case reference can be given to the determination in e.g. hair or nail, body tissue and further material from (the remains of) a living being. In that case the “fluid” is the extract from said tissue. Also direct analyses of solid samples can be performed, eg after thermal desorption or pyrolysis.

The use of multi-dimensional gas chromatography for analysis of chemical compounds as such is known in the art. Particularly the comprehensive two-dimensional gas chromatography can be used to analyse any compound by two different parameters. For these purposes two different separation columns are used, for example a first column comprising a non-polar material and a second column comprising a more polar material or vice versa. However, other combinations can also be used like e.g. enantiomeric separation.

Comprehensive two-dimensional gas chromatography as well as the combination of comprehensive two-dimensional gas chromatography with time of flight mass spectrometry (TOF-MS) is a known technique, described for example by Lu, X. et al in Journal of Chromatography A, 1043 (2004), pages 265-273, and recent developments in comprehensive two-dimensional gas chromatography are described by Adahchour, M. et al., in Trends in Analytical Chemistry, Vol. 25, No. 8, 2006, pages 821-840.

The use of comprehensive two-dimensional gas chromatography (GC×GC) as such for drugs analysis in doping control is known from an article from Kuch et al., in Journal of Chromatography A, 1000 (2003), pages 109-124. However, the process described in this article is laborious and is time consuming. Moreover, the performed sample preparation excludes a large number of compounds e.g. the diuretics.

The term “comprehensive” is used herein to indicate that essentially all the ingredients eluting from the first chromatographic column are introduced as different fractions in a second chromatographic column. Moreover, all components eluting from this second column can be detected, preferably by mass spectrometry, more preferably by TOF-MS.

In an optional step of the present invention, which is step (i), to the (body) fluid in “original” concentrated, diluted or anyhow treated form at least one enzyme is added under conditions where the enzyme(s) provide(s) its/their activity. The conditions (like e.g. temperature and buffer system) where the enzyme(s) show best activity conditions depend from the used enzyme(s) and are usually taught by the supplier. The enzyme preferably is selected from glucuronidase, glycolase and/or sulfatase/desulfatase. The addition of the enzyme results in decomposition of derivatives of compounds, e.g. metabolites of biochemical pathways, which typically are glycosylated or sulfonated. If appropriate, any other enzyme can be added to the (body) fluid for decomposition of pathway metabolites.

In a preferred embodiment according to the present invention any (body) fluid or extract is divided in several parts, wherein at least one part according to step (ii) of the fluid or extract is contacted with at least one first solid phase. Said first solid phase preferably is an organic material, more preferably selected from polydimethylsiloxane (PDMS), polyacrylate, carbowax-divinvinylbenzene (carbowax/DVB), PDMS-DVB, carboxen/PDMS, divinylbenzene-carboxene-polydimethylsiloxane (DVB/carboxen/PDMS), poly(methylhydrosiloxane) (PMHS) or other commonly known and used phases.

Carbowax™ and Carboxen™ are commercially available solid phases which are supplied by Supelco (Sigma-Aldrich).

In a particularly preferred embodiment the first solid phase is an organic fibre, preferably having a thickness of from 5 to 200 μm, preferably 10 to 200 μm, more preferably from 30 to 150 μm or it is a stir bar.

Such fibres are available on the market and are offered for solid phase micro-extraction processes (SPME). Prior to use the fibres preferably are conditioned, e.g. that they are heated to at least 200° C., preferably to at least 220° C., for at least 20 minutes, preferably for at least 30 minutes, more preferably for at least one hour, depending from the material which is used. The temperature to condition the fibres prior to use is provided by manufacturer's instructions. Any other conditioning might be applied resulting in a desired treatment of the solid phase, e,g, to flush it with an organic solvent or any other suitable treatment (including other temperatures or other desorption times)

Preferably, a second part of the fluid or extract according to step (ii) is contacted with a second phase, which can be a liquid, a gas or a solid phase. Thus, said second phase is used for liquid phase extraction e.g. by an organic solvent, gas extraction for volatile organic compounds or solid phase extraction (SPE). If the second phase is a solid phase, said second solid phase can be of any material known to be used for SPE processes, e.g. a silica based material, zirconia or another e.g. modified or unmodified polymeric material (e.g polystyrene-divinylbenzene copolymer PS-DVB, or polyacrylates). If modified, the material used is typically octadecyl modified, but other modifications can also be applied (e.g phenyl, octyl or even functionalized or non-functionalized material.) The materials usable for SPE are commonly known.

The compounds containing fluid or extract can be placed on the top of a precleaned/preflushed SPE column (just by eluting the liquid sample through the column) and thereafter the retained compounds can be desorbed, e.g. eluted with a solvent. For elution 0.1 to 20 ml, preferably 1-20 ml, more preferably 2-10 ml, typically 5 ml of solvent can be used, but it depends strongly from the SPE column, its dimension, the application, goal etc.

After contacting the first solid phase with a first part of the fluid or extract and/or the second phase with a second part of the fluid or extract, the compounds bound to or extracted in each of the phases are recovered, preferably desorbed or extracted. Therefore, according to step (v) of the present process the compound(s) bound to the first solid phase is/are desorbed by thermal desorption, e.g. by applying heat to the solid phase, or by liquid extraction or both. Immediately after desorption/extraction of the compound(s) which was/were absorbed or adsorbed to the first solid phase this/these compound(s) is/are analysed by (multi-dimensional) gas chromatography. Optionally compounds can be derivatized before or during desorption.

In case that for the second phase a solid phase is used, according to step (vi) the compound(s) adsorbed to the second solid phase is/are desorbed/extracted from said second solid phase by thermal desorption or solvent extraction. Optionally compounds can be derivatized before or during desorption.

The solvent(s) used in steps (iv) to (vi) can be optionally at least partially evaporated before analyzing the compounds.

Solvents usable for extraction/desorption of the compound(s) bound to the first and/or second solid phase depend mostly from the nature of the material used the first and/or second solid phase and the nature of the compound bound to said phase. In steps (iv), (v) and (vi) the same or different solvents can be used. Solvents suitable for the extraction step(s) are for example acetone, methanol, ethanol, methylacetate and similar. After extraction or desorption, the compound(s) immediately can be applied to gas chromatography.

In case for second phase a liquid, particularly an organic solvent is used the extract can be immediately applied to gas chromatography.

As an optional step, but as a preferred embodiment according to the process of the present invention the solvent(s) is/are evaporated at least partially after extraction or desorption of the compound(s) from the first and/or second solid phase or after recovering the compound(s) by liquid extraction. For further processing it is not necessary that the solvent is fully evaporated, but it is preferred to evaporate at least 50%, preferably at least 75%, more preferred at least 90% of the solvent. Evaporation can be carried out by any method known in the art, for example by heating, lowering the pressure (vacuum), freeze-drying, lypophilisation and further more.

Further it is preferred in the inventive process that after step (vi), particularly preferred before evaporation of the solvent component a derivatisation of the organic compound(s) is carried out, preferably by treatment with an alkylating and/or silanating and/or acetylating agent. Such agents are preferably methyliodide and/or MSTFA (N-Methyl-N-(trimethylsilyl)trifluoroacetamide), BSTFA (N,O-bis-(trimethylsilyl)trifluoroacetamide), BSA (N,O-bis[Trimethylsilyl]acetamide), MTBSTFA (N-Methyl-N-[tert-butyldimethyl-silyl]trifluoroacetimide) and similar compounds/agents. Such compounds/agents are known by skilled persons.

In an other embodiment of the invention the step of derivatisation can be carried out in any prior stage, e.g. before or after step (i), before or after step (iii) or before step (vi).

The above explained steps of the process according to the present invention are the steps for “sample preparation”, wherein the samples containing the compound(s) of the (body) fluid or extract thereafter are analyzed according to step (vii) by gas chromatography. In a preferred embodiment the compound(s) is/are analyzed by multi-dimensional gas chromatography, e.g. two-dimensional gas chromatography, more preferably by comprehensive multi-dimensional gas chromatography, wherein said comprehensive multi-dimensional gas chromatography can be coupled to mass spectrometry, preferably the so-called time of flight mass spectrometry and/or to a flame ionisation detector (FID) or other detection techniques.

According to a particularly preferred embodiment of the present invention the (body) fluid or extract can be divided in several parts, wherein a first part can be contacted with the first solid phase, preferably an organic fibre according to step (ii), and desorbed from said solid phase according to step (v), providing sample 1.

A second part of the (body) fluid or extract can be contacted with a second solid phase according to step (iii), the compounds adsorbed to the second solid phase are preferably desorbed with an solvent, which is thereafter preferably evaporated and the compound(s) desorbed from the second solid phase is/are treated with an alkylating agent, preferably methyliodide, before the derivative(s) of the compound(s) is/are desorbed from a second solid phase according step (vi), resulting in sample 2.

A third part of the (body) fluid/sample extract can be contacted (separately) with another solid or liquid phase (this could be but is not necessary identical to the second phase as described above). The compounds adsorbed or absorbed to this latter solid phase are thermally desorbed or desorbed with a solvent, which solvent thereafter is preferably evaporated and the compound(s) desorbed from the latter solid phase can be treated with a derivatizising agent, e.g. a silanating agent, for example with MSTFA, but other reagents could also be applied, resulting in sample 3.

The same result indeed is obtainable by dividing the (body) fluid in at least two parts, wherein the first part of the fluid is treated by SPME (≅first solid phase) as described above, and the second part is contacted with the second solid phase, the compound(s) is/are eluted and thereafter the sample containing the eluted compound(s) is divided in at least two parts for different derivatisation. Thus as well three different samples are obtained.

Therefore, according to the above particularly preferred embodiment of the present invention, compounds contained in the (body) fluid or extract are divided in (at least) three parts, resulting in (at least) three samples which all are differently treated, sample 1 by SPME, sample 2 by SPE, wherein the compound(s) is/are treated with an alkylating agent to provide alkylated derivatives of the compound(s), and sample 3 by SPE and treatment with a silanating agent, wherein silanated derivate(s) of the compound(s) contained in the (body) fluid or extract is/are obtained.

By dividing the original (body) fluid or extract in more than three parts, other derivatizations could be applied resulting in different derivatives of the compounds.

In a particularly preferred embodiment at least one, preferably two, more preferably all three samples obtained by the preferred embodiment as described above are analyzed by comprehensive multi-dimensional gas chromatography, wherein at least two different types of chromatography columns are used in series, for example a first non-polar column and a second more polar column. Preferably the first column is a large column of several meters, e.g. up to 20 to 100 meters, having a relative large diameter, e.g. 50-500 μm, whereas the second column is a shorter column, for example 1 to 5 meters, preferably 1 to 2 meters, having a small diameter, for example 50-150 μm. Thus, in the first column the compound(s) is/are separated for example mainly by boiling point of the compound(s), whereas in the second column the compounds exiting the first column are separated according to their polarity. According to the particularly preferred embodiment of the present invention the comprehensive gas chromatography is coupled further with mass spectrometry. Thus, the compound(s) separated first mainly by boiling point and second by polarity are determined further in a third step by their mass. One preferred type of mass spectrometry is the time of flight mass spectrometry (TOF-MS) which is a commonly known technique.

The different prepared fractions can either, however need not to be analysed in separate chromatographic runs, or they can be analysed all together in one chromatographic run. In a preferred embodiment all the samples are injected (together) into one chromatographic system. If different injections are used the different injections can be performed in parallel (using more than one injector) and/or in series. Different types of injection techniques can be used, preferably a PTV injection technique (Programmed Temperature Vaporization), but other injection techniques can be used also (hot-split, split less, on column etc.). Injection conditions can be optimized for the type of injection (SPME, liner, temperature, volume, including large volume injection, and order of introduction of the different fractions, etc.). After injecting all fractions, the gas chromatography is started, resulting in one “multidimensional” chromatogram when using a 2D-GC TOF-MS system. The (multidimensional) data obtained after the chromatography and spectrometry are collected and evaluated. The data evaluation preferably is made by data evaluation software, which is commercially available.

Having analysed the compound(s) which were present in the original (body) fluid or tissue/sample extract this/these compound(s) can be determined, e.g. by comparison with data of drugs or medicaments or their metabolites which are known from comparative processes. Preferably and in order to facilitate this comparison the analyst refers to a large overview of analytical data for known drugs or medicaments, present in a form of a database. Preferably such a database is a computer in which the reference overview is stored and with which a determination of the presence and nature of the medicament or drug or their metabolite(s) are facilitated. However, as well it is possible to perform the analysis without any database. The MS give a unique m/z pattern which includes the chemical structure of the compound. By the present process medicaments and drugs of doping classes S1 to S9, described by the WADA (world association of drug analysis) can be determined, except class S2 (peptides) which cannot be detected using gas chromatography based methods. Thus, the present process provides the possibility of very fast information, e.g. during official games like Word Championships or Olympic Games, in which the doping control commission has to decide about abuse of medicaments/use of doping material by one or more of the participants.

The components, which are used, particularly in sample preparation for multi-dimensional gas chromatography, can be provided in a kit containing at least several of the components for preparing the samples. In a preferred embodiment such a kit comprises at least one solid phase, preferably an organic solid phase in a column or a fibre form or a stir bar, able to adsorb organic compounds, at least a second solid phase different from said first solid phase, optionally at least one enzyme or a liquid containing same, optionally at least one alkylating and/or silanating and/or acetylating agent or a liquid containing same, optionally any organic solvent and optionally containers for sample preparation.

Such a kit can be used for preparation of the samples which thereafter can be analyzed by multi-dimensional gas chromatography.

Further according to the present invention a device is provided which can be used to carry out automatically at least several steps of the process of the present invention, preferably at least the sample preparation steps (ii), (iii), (v) and (vii) of the described process.

A device for carrying out the whole process with all the steps described in the present invention, e.g. an automat wherein only the (body) fluid sample or extract is introduced in a suitable container or input device and all the steps of the process are carried out automatically within the device, as well is part of the present invention.

### FIGURES

FIG. 1 shows a typical GC*GC/MS chromatogram obtained by the procedure according to Example 1. The compounds are separated by polarity and boiling point and x- and y-axis show the retention time in the chromatography (x-axis first retention time in seconds, y-axis second retention time in seconds).

FIG. 2 shows a typical GC*GC/MS chromatogram obtained by the procedure according to Example 2. The compounds are separated by polarity and boiling point and x- and y-axis show the retention time in the chromatography (x-axis first retention time in seconds, y-axis second retention time in seconds).

### EXAMPLES

The following Examples are provided to illustrate the invention without restricting the invention to the Example embodiments.

### Example 1

Sample=“spiked urine” with compounds from class S1,S3-S9=“spiked urine”. In total 37.5 ml urine. 25 ml was used for enzymatic treatment followed by SPE and derivatisation, while 12.5 ml was used for SPME.

Spiking Compounds (Table 1):

| | | Concentration |
|---|---|---|
| Compound | Class | (ppm) |
| aminoglutethimide | S4-3 | 13.9 |
| budesonide | S9-4 | 11.3 |
| chlorthalidone | S5-9 | 16.2 |
| clomiphene | S4-8 | 15.4 |
| ephidrine | S6-2 | 13.9 |
| epitestosterone | S1-26 | 16.8 |
| fenfluramine | S6-27 | 16.2 |
| formoterole | S3-2 | 4.8 |
| furozemide | S5-1 | 15.5 |
| hydrochlorothiazide | S5-2 | 17.5 |
| letrozole | S4-2 | 13.0 |
| methylephidrine | S6-13 | 6.4 |
| norephedrine | S6-11 | 16.5 |
| phentermine | S6-5 | 14.9 |
| prasterone (DHEA) | S1-7 | 15.2 |
| prednison | S9-5 | 13.4 |
| salbutamol | S3-3 | 8.7 |
| salmeterol | S3-4 | 14.0 |
| stanozolol | S1-3 | 12.5 |
| strychnine | S10-1 | 16.2 |
| terbutaline | S3-5 | 15.1 |
| THC—COOH (1000 | S8-1 | 0.5 |
| ppm in solution) | | |
| (=“canabis”) | | |
| triamcinolone | S9-1 | 11.9 |
| acetonide | | |
| triamterene | S5-5 | 16.7 |
| DHEA 3-sulfate | S1-57 | 11.0 |
| sodium salt | | |
| Morphine-3- | S7-5 | 11.4 |
| glucuronide | | |

### Enzyme Treatment:

Sample 1→12.5 ml spiked urine+850 μl 2M NaCl+1.65 ml Na acetate (1M pH 5)+1.65 ml Enzyme glucuronidase in solution (947 units/ml).
Sample 2→12.5 ml spiked urine+850 μl 2M NaCl+1.65 ml Na acetate (1M pH 5)+1.65 ml Enzyme sulfatase in solution (140 units/ml).
Treatment at 55° C.

### SPE and Derivatisation:

After 18 hours, samples 1 and 2 were mixed (combined sample) followed by SPE (SPE Waters (C18) SEP-Pak WAT 020515). The SPE material was conditioned by elution with 5 ml MeOH and 5 ml water (Milli-Q). The sample (25 ml) was put on the SPE material, followed by 1.5 ml water. The SPE material was put on vacuum (20 sec) to remove the water. The bounded compounds were eluted with 4.5 ml MeOH which first 0.5 ml part put to waste and 4.0 ml were collected. The 4 ml collect of MeOH containing the eluted compounds was split (fraction 1 and 2). Fraction 1 was evaporated to dryness and 1 ml MSTFA+1 ml pyridine were added. Fraction 2 was evaporated to dryness and 2 ml 10% methyliodide (Mel) in acetone+K₂CO₃±50-100 mg was added. Fraction 2 (with Mel, acetone and K₂CO₃) was stored overnight at 80° C.

### SPME:

The SPME material (carbowax) was conditioned for 0.5 hour at 220° C. before contact with the sample. The SPME extraction was performed for 1 hour with 12.5 ml spiked urine with 10% (w/w) NaCl.

### GC*GC-TOF-MS Analysis

The SPME fibre, 1 μl Mel solution (fraction 2) and 1 μl MSTFA-solution (fraction 1) were injected at 250° C. After injection the GC*GC analysis was started. Used conditions: column 1=30m (L)*0.25 mm (ID)*0.25 μm (df) VF-1 MS and column 2=1.0 m (L)*0.10 mm (ID)*0.10 μm (df) VF-23 MS. Gas He, 1 ml/min constant. Oven; 40° C. (1 min)-10° C./min-280° C. (15 min), oven 2; 40° C. (1 min)-10° C./min-260° C. (15 min), Modulator offset; +30° C. (hot jet temp), Sec dim time; 4 sec, Hot pulse time; 0.4 sec, MS scan rate; 150 Hz, Scan; 20-550.

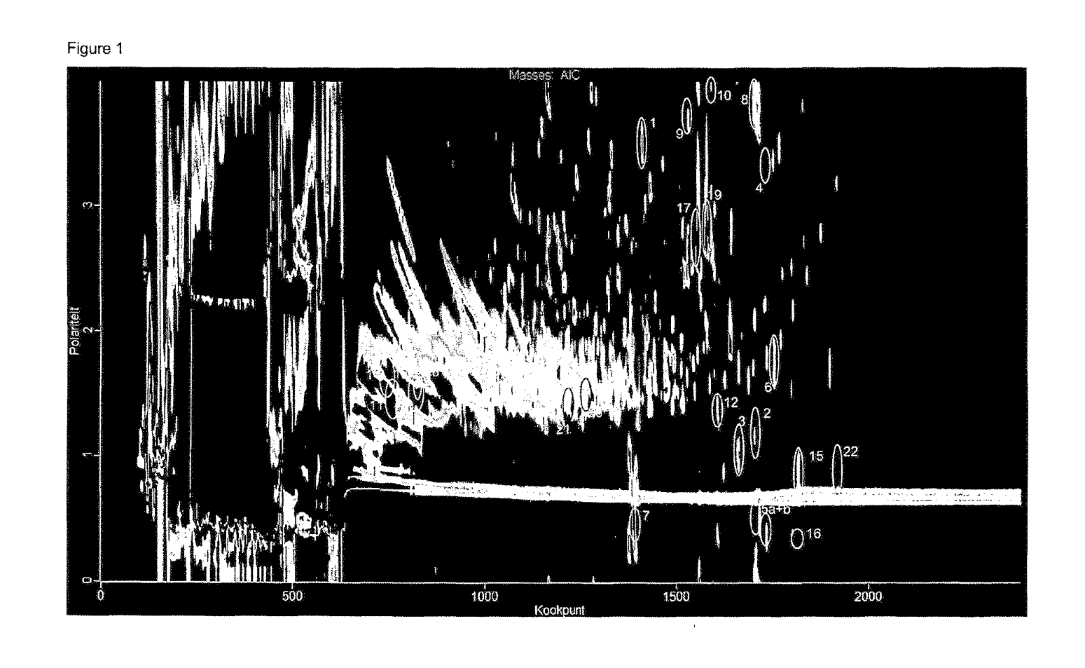

A typical GC*GC-MS chromatogram is shown in FIG. 1 (the spiked compounds are circled).

### Example 2

Sample=“spiked urine” with compounds from class S1,S3-S9=“spiked urine”. In total 30 ml urine. 25 ml was used for enzymatic treatment followed by SPE and derivatisation, while 5 ml was used for SPME.

The spiked compounds at 10 (mg/kg) ppm level (table 2):

| No | Name | Class |
|---|---|---|
| 1 | amonigluthetimide | S4 |
| 2 | chlorothalidone | S5 |
| 3 | furosemide | S5 |
| 4 | hydrochlorothiazide | S5 |
| 5 | stanozolol | S1 |
| 6 | triamterene | S5 |
| 7 | salbutamol | S3 |
| 8 | clomiphene | S4 |
| 9 | prasterone (DHEA) | S1 |
| 10 | terbutaline | S3 |
| 11 | fenfluramine | S6 |
| 12 | letrozole | S4 |
| 13 | methylephedrine | S6 |
| 14 | phentermine | S6 |
| 15 | strychnine | S6 |
| 16 | budesonide | S9 |
| 17 | triamcinolone acetonide | S9 |
| 18 | ephedrine | S6 |
| 19 | epitestosteron | S1 |

### Enzyme Treatment:

sample 3→12.5 ml spiked urine+850 μl 2 M NaCl+3.3 ml glucuronidase solution (947 units enzyme/ml 1 M Na acetate (pH 5)).
Sample 4→12.5 ml spiked urine+850 μl 2 M NaCl+3.3 ml sulfates solution (140 units enzyme/ml 1M Na acetate (pH 5)).

### SPE and Derivatisation:

After 18 hours of enzymatic reaction at 37° C., samples 3 and 4 were mixed (combined sample) followed by solid-phase-extraction (SPE, Waters (C18) SEP-Pak WAT 020515). The SPE material was conditioned by elution with 5 ml methanol (MeOH) and 5 ml water (ultra-pure water, Milli-Q). The sample (total volume of approx. 33 ml) was put on the SPE material, followed by elution of 1.5 ml water. Vacuum (20 sec) was used to remove the water of the SPE material. The bounded compounds were eluted with 4.5 ml MeOH; the first 0.5 ml of eluate were waste and the following 4.0 ml were collected. The collected 4 ml contained the eluted compounds and were split into fraction 1 and 2. Fraction 1 was evaporated to dryness and 0.5 ml N-Methyl-N-(trimethylsilyl)trifluoroacetamide (MSTFA)+0.5 ml pyridine were added. The silylation reaction took place within 1 hour at room temperature. Fraction 2 was evaporated to dryness and 1 ml 10% methyljodide (Mel) in acetone and approx. 50-100 mg K₂CO₃ were added. Fraction 2, which contains Mel, acetone and K₂CO₃ was stored overnight at 80° C. to proceed the methylation reaction.

### SPME:

The SPME material (Carbowax, film thickness 65 μm, Supleco) was conditioned for 0.5 hour at 220° C. before contact with the sample. The SPME extraction was performed for 1 hour with 5 ml spiked urine with 0.5 g NaCl (10%, w/w) added to the urine.
   GC*GC-TOF-MS analysis
The SPME fibre, 1 μl Mel solution (fraction 2) and 1 μl MSTFA-solution (fraction 1) were injected at 250° C., using an optimised sequential injection procedure (splitless). After injection of the SPME and the different fractions, the GC*GC analysis was started. Used GC*GC-TOF-MS conditions were: column 1=30 m (length)*0.25 mm (internal diameter)*0.25 μm (film thickness) VF-1 MS (Varian) and column 2=1.0 m (length)*0.10 mm (internal diameter)*0.10 μm (film thickness) VF-17 MS (Varian). Gas He, 1 ml/min constant flow. The first oven (first dimension separation); 40° C. (isothermal for 1 min)−10° C./min-280° C. (15 min isothermal), the second oven (second dimension separation); 40° C. (1 min isothermal)−10° C./min-260° C. (15 min iosthermal), Modulator offset; +30° C. (hot jet temp), Second dimension time; 4 sec, Hot pulse time; 0.4 sec, MS scan rate; 150 Hz, Scan range MS; 20-550.

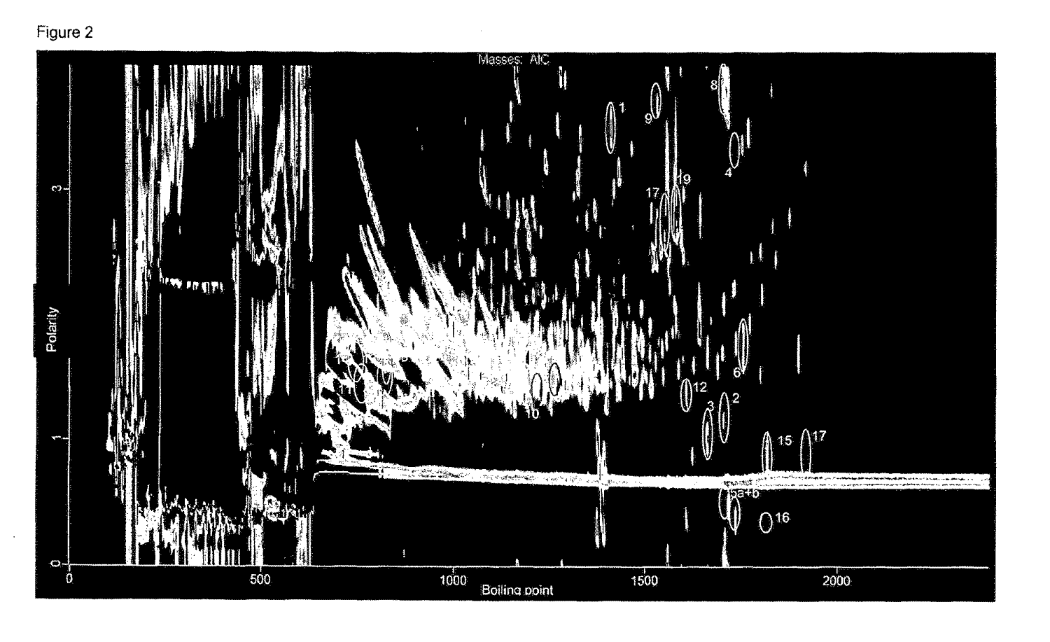

A typical GC*GC-MS chromatogram is shown in FIG. 2 (the spiked compounds are circled).

1. Process for determination of a drug or medicament or their metabolites in a (body) fluid or an extract of (body) tissue or (body) sample comprising sample preparation comprising the steps
(i) contacting at least a first part of the fluid or extract with at least one first solid phase able to adsorb or absorb organic compounds out of the fluid or extract,
(ii) contacting at least a second part of the fluid or extract with at least one second phase, able to extract or adsorb organic compounds out of the fluid or extract,
(iii) optionally contacting at least a third part of the fluid or extract with a liquid phase able to extract organic compounds out of the fluid or extract,
(iv) desorbing the compound(s) bound to the first solid phase by applying heat to the solid phase and/or by solvent extraction, optionally followed by evaporating the solvent at least partially,
(v) extracting or desorbing the compound(s) contained in or bound to the second phase by applying heat and/or by solvent extraction, optionally followed by evaporation of the solvent at least partially
and subsequently analyzing the desorbed compounds of steps (iv) and (v) and optionally the compounds extracted in step (iii) by multi-dimensional gas chromatography (GC), preferably by comprehensive multi-dimensional GO (GC*QC) coupled preferably to a mass spectrometry, by injecting the desorbed compounds of step (iv) and (v) and optionally the compounds extracted in step (iii) into one gas chromatography system and starting the gas chromatographic analysis after Injecting the compounds of all sample preparation steps.

2. Process according to claim 1, wherein during the sample preparation the fluid or extract is first treated with at least one enzyme.

3. Process according to claim 2, wherein the at least one enzyme is selected from glucuronidase, glycciase and desuifatase.

4. Process according to claim 1, wherein the first solid phase in step (i) is an organic material.

5. Process according to claim 4, wherein the first solid phase In step (i) is selected from polydimethylsiloxane (PDMS), polyacrylate, carbowax-divinvinylbenzene (carbowax/DVB), PDMS-DVB, carboxen/PDMS, divinylbenzene-carboxene-polydimethylsiloxane (DVB/carboxen/PDMS), poly (methylhydrosiloxafle) (PMHS).

6. Process according to claim 4, wherein the first solid phase is in fibre form or a stir bar.

7. Process according to claim 1, wherein the second phase of step (ii) is a solid phase, preferably a silica containing material or a modified or unmodified polymeric material or a liquid phase.

8. Process according to claim 7, wherein the material of the second solid phase of step (iii) is selected from silica based stationary phase, or zirconica, PS-DVB copolymer or polyacrylates or the liquid phase is a solvent with the condition that It is not miscible with the sample fluid or sample solution.

9. Process according to claim 1, further comprising a step of derivatisation of the organic compound(s).

10. Process according to claim 9, wherein the derivatisation is obtained by treatment with an alkylating and/or silanating and/or acetylating agent(s).

11. Process according to claim 1, wherein the body fluid is blood or urine of a mammal.

12. Process according to clam 1, wherein at least part of the steps of the sample preparation and the gas chromatography are carried out automatically.

13. Device for carrying out automatically at least steps (i), (ii), (iv) of the sample preparation and gas chromatography of the process of claim 1.

14. Kit or device for carrying out the sample preparation steps (i) to (vi) of the process according to claim 1, comprising
a. at least a first solid phase able to adsorb organic compounds
b. at least a second phase different from said first solid phase
c. optionally at least one enzyme, selected from glucuronidase, glycolase and/or desuifataso, or a solution containing same
d. optionally any organic solvent
e. optionally an alkylating, a silanating and/or an acetylating agent or a solution containing same
f. optionally containers for sample preparation.
